(19) United States
(12) Patent Application Publication
(10) Pub. No.: US 2006/0160463 A1
(43) Pub. Date: Jul. 20, 2006

(54) Enhanced performance twirling baton

(75) Inventors: Susan Dailey Orr, Indianapolis, IN (US); Max S. Orr, Naples, FL (US); John Arthur Spees, Indianapolis, IN (US)

Correspondence Address: Max S. Orr, 8574 Pepper Tree Way, Naples, FL, 34114, US

(73) Assignee: Batons Unlimited, Inc., Mooresville, IN (US)

(21) Appl. No.: 11/322,505

(22) Filed: Dec. 30, 2005

Related U.S. Application Data
(60) Provisional application No. 60/645,065, filed on Jan. 19, 2005.

(51) Int. Cl. A63H 1/00; G10G 7/00

(52) U.S. Cl. 446/236; 84/477 B; 984/258

(57) ABSTRACT

Over the years, batons have not changed much in size or shape. The ends of the baton are still rubber with a steel shaft in between. Little has been done to prevent the baton from slipping out of the twirler's fingers due to moisture or to keep the baton from rolling away when dropped. The primary essence of this patent is to reduce rolling action and bounce when dropped as well as slippage due moisture. This patent introduces a newly designed ball and tip that is in the general shape of a tetrahedron that transitions into a frustum shape that connects the ends to the shaft. The functional shape of baton ends appears to be an equilateral triangle when viewed looking down the axis of the baton shaft. The effect of this design is that three flat surfaces on each end of the baton are oriented so that the flats are in the same plane with each other, which creates resistance to rolling. A non-slip surface has also been created in the center of the baton to reduce the tendency of the baton to slip in wet conditions but will not harm the twirlers fingers. Low resilient synthetic rubber ends have as well been incorporated into the design to diminish the bounce effect when dropped.

### CROSS REFERENCE TO RELATED APPLICATIONS

A Provisional patent was filed for this same invention. It can be found under application No. 60/645,065. The provisional patent application date of filing was Jan. 19, 2005 and the confirmation number is 1879. A Design patent application was also filed for the design of a heart shape on the ends of the enhanced performance twirling baton and can be found under application number Ser. No. 29/225,859. It was filed on Mar. 21, 2005. The unit art number assigned was 2912 and the confirmation number is 6313.

### FEDERALLY SPONCERED RESEARCH

Not applicable

### BACKGROUND OF THE INVENTION

The field of endeavor for this invention is a baton used for twirling. This is related to music or Class 84 in that twirling is most often done with music accompaniment and in the early days of the use of the baton, the baton was used to help keep time with the beat of the music such as in a marching band. This invention relates to batons used for twirling purposes, which is subclass 477B of the USPTO classification system.

Batons were invented in the 1800 period and have evolved in size and shape to the present day baton, which is a steel shaft that has been plated with a material that reduces corrosion. Drum majors in front of a band first used them so that the band could watch the motion of the baton or mace and keep time with the music. Research shows that bands and military formations have been using a device such as a shaft, mace, or rifle for years in Europe dating as far back as the 1700's. The present day baton has gone through a transformation over the past century. A rubber ball and tip evolved on each end of the wand and the baton became shorter and smaller in diameter as it matured. Records were found showing that a wooden baton was used as far back as 1921 and rubber balls were added to each end to make it resilient. Present day batons generally range in length from 22 to 30 inches. The shaft is typically made of a metallic material such as carbon steel or stainless steel tubing and generally ranges in thickness from ⅜ to 7/16 inches in diameter. There are batons on the market that have plastic shafts, lighted shafts and ends, hoops around the shaft and shafts with flags attached. Several inventions have been found with a handle or knob to hold while the twirler is spinning the baton. Batons are also twirled with fire on the ends accomplished by adding an absorbent material to the ends of the shaft and soaking them in a flammable material.

As the baton evolved, the two equal sized balls on the end became configured so that one end was larger than the other. Because of the larger size of the ball end, counterbalance weights are generally added to the baton shaft to keep the baton balanced about the geometric center. Research shows that while several patents have been filed regarding baton design, numerous sizes and shapes are on the open market that have not been protected by a patent. Our search has revealed over 40 patents dating back to as early as 1920 involving batons, but it is estimated that hundreds of designs are on the market today that have never been patented. Where this was discovered, care was taken not to attempt to patent what could be called prior art. The sport of baton twirling has reached monumental proportions and participation is likely in the hundreds of thousands when considering high school bands, twirling organizations and the general public. Supporters are even petitioning Olympic officials there to have inclusion as an event for future games.

The primary inventor of this enhanced performance baton has been in the baton twirling field for over 35 years as a twirler, coach and judge and has observed that there are several reasons some perform better than others when twirling the baton. While there is no substitute for practice and hard work on the part of the twirler, one issue is that the baton when dropped has potential energy stored that is converted to kinetic energy when it hits the ground or surface. To dissipate that energy, the baton usually bounces or rolls a great distance depending on the speed and angle it comes in contact with the surface as well as the amount of angular momentum of the spinning baton. The twirler is momentarily stopped from performing and must retrieve the baton in order to restart the routine. In the event of a contest, a dropped and lost baton deducts points, or in the event of a show performance, it detracts from the routine. A way to diminish the rolling or bouncing effect of a dropped baton is one of the claims that this invention will address. Another problem for the twirler while performing the routine is that the twirler often develops sweaty hands or has to twirl in the rain. Most of the shafts on a typical baton are slick and have a smooth finish, which prevents the performer or twirler from maintaining a good grip, thus resulting in a dropped baton. This invention also will address that issue in a way that will reduce the chance of dropping a baton due to the inability keep the baton secure while twirling in wet conditions. Our design addresses the center of the shaft and the creation of a surface that significantly improves the twirlers ability keep a grip and maintain control in wet conditions. As previously mentioned when the baton was first invented, the idea was to create a stick that would bounce and work as an entertainment toy for the user. Since this has now become a refined art and sport, the idea is not to bounce or drop the baton, but to keep it in the twirlers control at all times. The baton bounce is a problem, which causes the twirler to have to chase after and retrieve the baton in order to restart the routine. Claims are made in this invention to reduce bounce, which also improves the performance of the baton twirler as well as a claim made in regards to a non-slip surface in the center of the baton shaft.

### BRIEF SUMMARY OF THE INVENTION

As a result of the three specific problems experienced in the field of baton twirling, this patent was created i.e. the baton rolls away, is slippery when wet & bounces excessively when dropped.

As a result of the problems that a baton twirler faces when performing, this invention was created. Its intent is to enhance the performance of the twirler by reducing drops, reducing the distance that a baton rolls away when dropped and reducing the amount of bounce when the baton hits the surface. In short, this is accomplished by creating a modified tetrahedronal shape on the ends of the baton that are timed so that they are oriented in the same angular position about the baton shaft with respect to each other. When viewed looking down the shaft of the baton a triangular shape is created which creates flat surfaces for the baton ends. This makes it much more difficult for the baton to roll since it has the effect of an axle with triangular shaped wheels that do not roll as easily as round shapes. This claim is one of the primary claims of the invention. The next major claim is the non-slip center section of the baton shaft. This new feature has been created to allow the twirler to twirl even though the surface of the baton is wet or the twirlers hands are wet. Creating an abrasive surface that has microscopic roughness that allows the twirler to maintain a firm grip does this. The non-slip surface created is a result of experimentation and testing to develop a surface that will not injure the twirlers fingers yet still allow the twirler to maintain a controlled grip on the baton.

The third primary claim is the innovation of utilizing a rubber material that has been researched to produce a diminished bounce when compared to rubber being utilized by other baton manufacturers. This also reduces the baton twirlers effort required to retrieve the baton and proceed with the performance.

The other claims are associated with how to lock the triangular ends into a timed position, how to utilize a counter balance weight design that facilitates the timing of the baton rubber ends and coatings that keep the non-slip surface from wearing out during the life cycle of the baton as well as adding an aesthetic effect.

Not only is baton twirling a competitive sport; it is also done for show and entertainment. One of the baton twirlers fears is dropping the baton or having it roll away during a performance. The inventor, and expert in the field, has determined that by creating a baton that diminishes the possibility of a drop or reduces the distance that a baton rolls when dropped, will enhance the baton twirler's performance. To that end, this baton's shape and characteristics have been invented. In the past, batons have typically had ends that are called the ball (large end) and the tip (small end) that are concentric about the centerline of the shaft such as a circular end or multifaceted end. This invention creates a ball and tip with three equal sides on the ball and tip forming a triangular shape when viewed form the end of the baton. There have been batons with star shapes on the end, which tend to roll less than an oval shape. There has never been a baton that has three equal sides on each end and are timed with each other. By having three flat surfaces that are in a plane parallel to the centerline of the shaft of the baton, the flat surfaces act as frictional breaks when in contact with the surface. It is also apparent that a three-sided figure will not roll as readily as a round configuration on the end of the baton. In order for the three-sided system to work, the baton ends (tip and ball) must be timed so that the flats stay in the same plane. This is accomplished by securing the ball and tip to the shaft so it will not slip and lose its timing. The features required to accomplish this are claimed in this invention.

The next feature, which is another claim, is the creation of a surface in the center of the baton approximately eight inches in length that has been conditioned to create a surface that significantly reduces slippage due to moisture such as sweat or rain. Other manufacturers of batons in the past have attempted to solve this problem by such techniques as knurling, machining grooves in the center of the shaft, and by dimpling. Present day twirlers wrap tape around the baton to reduce slippage. Baton twirlers have complained that grooves and knurled surfaces cut or fray the fingers and are not effective when wet. In this patent the surface in the center of the baton produces a satin type of finish that allows the fingers to grip when moisture or liquid is present. It has even been tested with soapy water applied to the hands and the twirler can still grip and maintain control of the baton.

The next significant feature that enhances the baton twirler's performance is the reduction of bounce when the baton is dropped. Tests were conducted with various rubber and vinyl compounds and the one selected (to the best of our knowledge) has never been used to produce the ball and tips for twirling batons. The rubber compound, while commercially available, has been mixed to a specific formula for the baton ends that significantly reduces the bounce of the baton when compared to the rubber currently being used in baton manufacturing.

The final result of this invention is that the baton twirler has in her hands a product that will reduce the mistakes and distractions caused by the baton rolling or bouncing away or slipping out of her hands. Since the provisional patent was filed, this baton has been put in the field and tested and the results show that it does indeed enhance the performance of the baton twirler and will likely become the baton of the future for serious twirlers.

### BRIEF DESCRIPTION OF DRAWINGS

FIG. 1 is an exploded view of the enhanced performance baton.

FIG. 2 is an assembled view of the baton.

FIG. 3 is an enlarged view of the ball end of the baton.

FIG. 4 shows where sections 5, 5a and 5b were taken through an enlarged view of the ball end.

FIG. 5 is an enlarged sectional view of the baton ball end showing the ball, counterbalance weight and part of the baton shaft.

FIG. 5a is an enlarged sectional view of the baton ball end showing the ball, an alternative counterbalance weight design and part of the baton shaft.

FIG. 5b is an enlarged sectional view of the ball end showing the cast cavity for the baton shaft in the rubber material.

FIG. 6 is an enlarged perspective view of the enhanced performance baton ball end and part of the baton shaft.

FIG. 7 is an end view of the baton tip and ball end viewed from the tip end toward the ball end.

FIG. 7a is an end view of the baton tip end viewed from the tip end toward the ball end of the baton.

FIG. 8 shows where section 9 and 9a was taken through the tip end.

FIG. 9 is an enlarged sectional view of the performance baton tip end showing the tip, counterbalance weight and part of the baton shaft.

FIG. 9a is an enlarged sectional view of the performance baton tip end showing the tip, an alternative counterbalance weight design and part of the baton shaft.

FIG. 10 is a view of plane Q showing how the baton ends rest on a flat surface.

FIG. 11 shows a diagrammatical view of the baton looking from the tip end toward the ball end and resting on plane Q.

FIG. 12 is a perspective view of the baton shaft showing the anti-slip surfaces and where section 13 was taken.

FIG. 13 is an enlarged diagrammatical view of section 13 showing the anti-slip surface and its internal components.

FIG. 14 shows where sectional view 15 and 15a was taken through the ball end.

FIG. 15 is enlarged cross view of the enhanced performance baton ball end.

FIG. 15a shows an enlarged sectional view of the ball end with an alternatively designed counterbalance weight.

FIG. 16 shows where sectional view 17 and 17a was taken through the tip end.

FIG. 17 is an enlarged cross view of the enhanced performance baton tip end.

FIG. 17a shows an enlarged sectional view of the tip end with an alternatively designed counterbalance weight.

FIG. 18 shows where sectional view 19 was taken.

FIG. 18b shows where sectional view 19b was taken.

FIG. 19 sectional view of ball end counterbalance weight.

FIG. 19a shows a sectional view of alternatively designed ball end counterbalance weight.

FIG. 20 perspective view of ball end counter balance weight.

FIG. 20 is a perspective view of ball end alternatively designed counterbalance weight.

FIG. 21 shows where sectional view 22 was taken of the tip end counter balance weight

FIG. 21a shows where sectional view 22a was taken of the alternatively designed counter balance weight.

FIG. 22 shows a sectional view of the tip end counterbalance weight.

FIG. 22a shows a sectional view of an alternatively designed tip end counterbalance weight.

FIG. 23 perspective view of the tip end counterbalance weight.

FIG. 23a perspective view of and alternatively designed tip end counterbalance weight.

### BRIEF DESCRIPTION OF DETAILS

Detail 24 rubber ball end of baton.

Detail 24a flat surface of rubber ball end of the baton.

Detail 24b flat surface of rubber ball end of the baton.

Detail 24c flat surface of rubber ball end of the baton.

Detail 25 ball end counterbalance weight.

Detail 25a alternatively designed ball end counterbalance weight.

Detail 26 grit blasted ball end of the baton shaft designed to accommodate bonding.

Detail 27 baton shaft.

Detail 27a nickel plating on the baton shaft.

Detail 27b chrome plating on the baton shaft.

Detail 28 non-slip surface of the baton shaft.

Detail 29 grit blasted tip end of the baton shaft designed to accommodate bonding.

Detail 30 tip end counterbalance weight.

Detail 30a alternatively designed tip end counterbalance weight.

Detail 31 rubber tip end of the baton.

Detail 31a flat surface of rubber tip end of the baton.

Detail 31b flat surface of rubber tip end of the baton.

Detail 31c flat surface of rubber tip end of the baton.

Detail 32 frustum of cone of rubber ball end of baton.

Detail 33 epoxy between the baton shaft and rubber ball end on the baton.

Detail 34 epoxy between counterbalance weight and shaft of the baton on the ball end.

Detail 35 frustum of cone of rubber tip end of baton.

Detail 36 epoxy between counterbalance weight and rubber tip end on the baton.

Detail 37 epoxy between counterbalance weight and shaft of the baton on the tip end.

Detail 38 is the cast section of the ball end that is designed to accept the baton shaft and counterbalance weights.

Plane Q shows a plan representing a flat surface such as the ground that the baton rests when dropped.

### DETAILED DESCRIPTION OF INVENTION

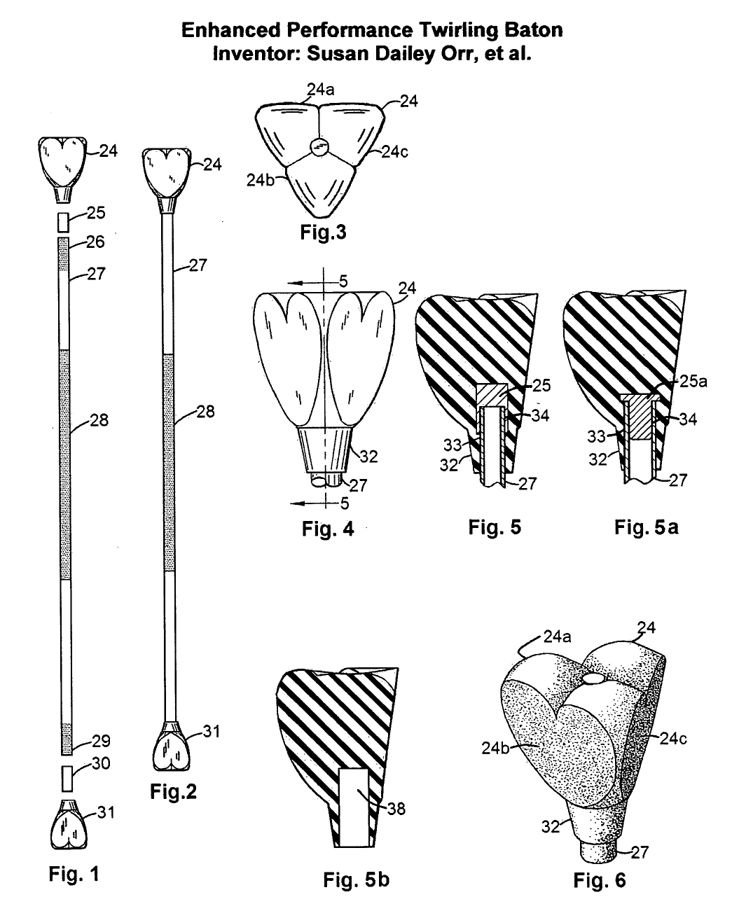

FIG. 1 is an exploded view showing how all of the details assemble together to become an enhanced performance twirling baton. The enhanced performance baton is made up of six basic components: They are detail 24, which is the rubber ball end; detail 25, which is a ball end counterbalance weight, detail 27, which is the baton shaft, detail 28 which is the non-slip surface of the baton shaft, detail 30 which is the tip end counterbalance weight and detail 31 which is the rubber tip end of the baton. Also shown in this drawing are details 26 and 29 which are the ends of the baton shaft that have been surface treated to allow proper bond by and epoxy to hold the rubber ends on the baton.

It should be noted that detail number 24, the ball end is approximately 20% larger than detail 31, the tip end. Other than size, the ball and tip ends are the same in design. Likewise, the counter balance weights, detail number 25, the ball end counterbalance weight and detail number 30 are also the same in shape but only differ in size to act as weights to properly balance the baton about its geometric center.

Detail 24 is produced from a white synthetic rubber polymer that has been designed and tested to reduce the bouncing motion of the baton when it is dropped. Detail 27 is the baton shaft that has been produced using 4150 carbon steel tubing that has been hardened and tempered to a hardness of RC 50 to provide strength and durability and it has been polished to create a smooth surface for chrome plating and a bright finish. Nickel has been plated over the steel shaft to allow adherence to of the chrome and to create a hard surface. Detail 28 is an anti-slip surface created by utilizing a grit blast method to create a surface rough enough to reduce slippage when wet, but not so abrasive as to harm the skin on the twirler's fingers when performing. Detail 31 is the tip end of the baton and is identical on the outside to detail 24 except it has been scaled down to 20% of the size of detail 24. The internal section of the tip end has been made to accommodate a larger counterweight, which is Detail 30. Other than being larger, Detail 30 is identical to Detail 25, which is the counterbalance weight for the ball end.

FIG. 1 is used to illustrate and support claims all claims except, 9, 10 and 13. Claim number 9 is the use of a chemical coating to improve wear on non-slip surface of the baton shaft. Claim number 10 is the use of a coating such as black oxide to color non-slip surface of the baton shaft and claim number 13 deals with the chemical compound to reduce bounce. In reference to claim number 1, it is stated that that there are three flat surfaces. In this drawing, this flat surface has been designed in the shape of a heart. This is for novelty and ornamental purposes; it is the flat surface that is functional and acts to slow the rolling motion of the baton when dropped by a baton twirler.

FIG. 2 is an assembled view of the enhanced performance baton. Detail 24 shows the ball end oriented so that the flat sections of the triangular shaped ends are in the same relative position on the shaft as the tip end, which is detail 31. By observing the heart shaped flat surface it is clear to the viewer that the flat surfaces are in the same relative position. The fact that the ball and tip are timed, causes the flat surface to act a break and anti-roll device when the baton is rolled along a surface or the ground. This effect is similar to attempting to roll a solid axle with two equilateral triangular stationary wheels on each end. In order for the axle to roll, it must be raised as it rotates over the apex of the three sides in order to fall on the next flat surface. This absorbs energy and diminishes the rolling effect. If this view were rotated 120 degrees, it would show the same view since every 120 degrees the view looks the same. This is because there are three sides to the ball and tip and they have been designed to maintain relative positions to each other. This drawing also shows that the shaft, detail 28, has a non-slip surface in the geometric center of the shaft. The anti-slip surface was obtained by grit blasting thus creating a finish that will grip the fingers rather than a slick finish that is difficult to hold when wet. Care has been taken to produce a finish that is between 100 RMS and 150 RMS so that slipping can be minimized yet not be so abrasive as harm the fingers as the baton is twirled.

This figure supports and illustrates claims numbers 1, 2, 3 and 8.

FIG. 3 is an end view of the ball end of the baton or detail 24. What it shows is that the ends of the baton have been formed in triangular shape so it has three equal and flat sides when viewed from the end of the baton looking down the axis of the baton shaft. In this figure, each of the flat surfaces of the baton ends has been labeled 24a, 24b and 24c. It will be shown later in this description that they line up with the other end, detail 31 and sides 31a, 31b and 31c when placed on a flat surface.

This figure supports and illustrates claim numbers 1, 2 and 3.

FIG. 4 shows where a cross sectional view 5 is taken through the baton rubber end. Detail number 32 is also shown in this figure, which is a frustum of a cone section that transitions the triangular shape of the baton rubber end onto the baton shaft.

FIG. 5 is an enlarged cross sectional view of the enhanced performance baton ball end. This drawing shows that the synthetic rubber end molded around the ends of the counterbalance so that there is no gap between the rubber of the ball, detail 24 and the counterbalance weight, which is detail 25. The same is true for the tip end as shown in FIG. 31. The counterbalance weight helps to create a locking characteristic between rubber ball and the counterbalance weight. This will also create a bond between the steel counterbalance weight and the synthetic rubber baton ends. In order to avoid rotation between the shaft and the counterbalance weight, epoxy cement, detail number 33 is added between the shaft, detail 27, and the counterbalance weight, which is shown as detail 25. The epoxy between the baton shaft and the counter balance weight is detail number 34. In this case, the shaft has been grit blasted to facilitate a solid bond between details 25, and details number 27. This grit blasted surface is described as detail number 26. This grit blasted surface is approximately the length of the depth that the shaft fits into the rubber end.

This figure supports and illustrates claim numbers 3, 4, 5, 6 and 7.

FIG. 5a is identical to FIG. 5 except that an alternatively designed counterbalance weight has been used.

FIG. 5b is a sectional view of the rubber ball end of the baton. This rubber part is injection molded by heating rubber and hydraulically forcing it into a steel cavity. It shows how the rubber material is cast to leave an opening for the baton shaft and counterbalance weights. Detail 31 represents this surface in FIG. 5b. The surface of the rubber is ground by utilizing a rough sanding sleeve to condition the surface and permanently bond the counterbalance weight and baton shaft to the rubber material by the use of an epoxy glue. By having a rough surface both on the shaft, counterbalance weights and the rubber, the epoxy glue hardens and forms itself within the rough surface creating a bond that is unlikely to come off during the process of twirling the baton. It is also vital that the ends be locked into position to maintain proper orientation between the flat surfaces of the baton ends.

This figure supports and illustrates claim numbers 2, 3, 4, and 5.

FIG. 6 is enlarged perspective view of the enhanced performance baton ball end which is described as detail number 24. As shown in detail 24, the three sides are equally spaced and have been designed as heart shape. This heart shape is ornamental and not functional. What is functional is the flat surface of the heart face. It is possible to use various shapes on this surface as long as it remains flat. What is significant is the three sides act as and an anti-roll device when placed on the baton ends and timed so that they contact the surface at the same time when the baton is dropped. The smaller end of the ball is in frusto-conical shape that wraps around the ball and creates a transition section of the ball end, detail number 24 and the baton shaft, detail number 27. This transitional section is shown as detail 32 on the drawing.

This figure supports and illustrates claim numbers 1 and 2.

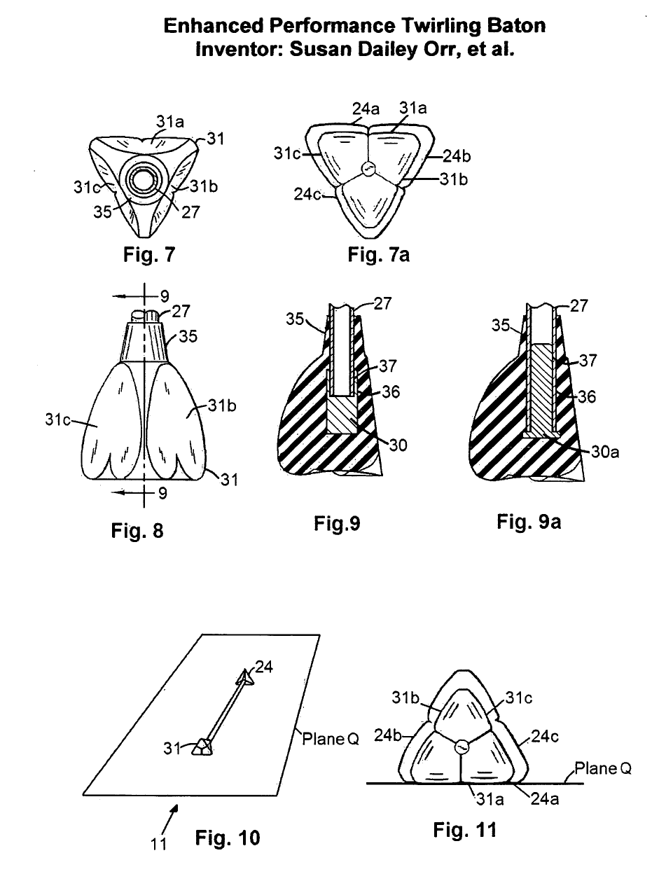

FIG. 7 is an end view of the tip end of the baton or detail 31. What it shows is that the ends of the baton have been formed in triangular shape when viewed from the end of the baton looking down the axis of the baton shaft. In this figure, the flat surfaces of the baton ball end are labeled 24a, 24b and 24c. It can be noted that these surfaces line up with surfaces 31a, 31b and 31c of detail 31, which is the tip end of the baton.

It can also be seen in this view that detail number 31 or the tip end is approximately 20% the size of detail number 24 or the ball end of the baton.

This figure supports and illustrates claim numbers 1, 2 and 3.

FIG. 8 shows where a cross sectional view 7 is taken through the baton rubber end. Detail number 35 is also shown in this figure, which is a frustum of a cone section that transitions the triangular shape of the baton rubber end onto the baton shaft.

FIG. 9 is an enlarged cross sectional view of the enhanced performance baton tip end. This drawing shows that the synthetic rubber end molded around the ends of the counterbalance so that there is no gap between the rubber on of the tip, detail 31 and the counterbalance weight, which is detail 30. The counterbalance weight helps to create a locking characteristic between rubber tip and the counterbalance weight. This will also create a bond between the steel counterbalance weight and the synthetic rubber baton ends. In order to keep the shaft from rotating in the counterbalance weight, epoxy cement, detail number 36 is added between the shaft, detail 27 and the counterbalance weight, which is shown as detail 30. The epoxy between the baton shaft and the counterbalance weight is detail number 37. In this case, the shaft has been grit blasted to facilitate a solid bond between detail 25 and detail number 27. This grit blasted surface is described as detail number 29. The length of the grit blasted surface is equivalent to the depth that the shaft fits into the rubber end.

This figure supports and illustrates claim numbers 3, 4, 5, 6 and 7.

FIG. 9a is identical to FIG. 9 except that an alternatively designed counterbalance weight has been used.

The counter balance weight for the tip end is larger than the one for the ball end in order to properly balance the baton about its geometric center.

This figure supports and illustrates claim numbers 3, 4, 5 and 6.

FIG. 10 is provided to show the enhanced performance baton on a plane Q. This plane can be considered the surface that the baton comes in contact with if it is dropped by the baton twirler. Detail number 11 is the view of the baton looking toward plane Q and down the axis of the baton shaft from the tip end toward the ball end of the baton.

This drawing illustrates and supports claim numbers 1, 2 and 3.

FIG. 11 is an end view of the baton looking from the tip end of the baton toward the ball end of the baton and resting on plane Q. This view shows the baton resting on plane Q on surfaces 31a and 24a. The flat surfaces have been labeled 24a, 24b and 24c on the ball end, which corresponds to surfaces 31a, 31b and 31c on the tip end of the baton Because the ball and tip are permanently locked into position on the baton shaft, the flat surfaces of the baton will always rest on the surface. As described previously, this condition causes the baton to resist rolling when the shaft is forced along the surface by the momentum of a throw or accidental drop of the baton.

This figure supports and illustrates claim numbers 1, 2 and 3.

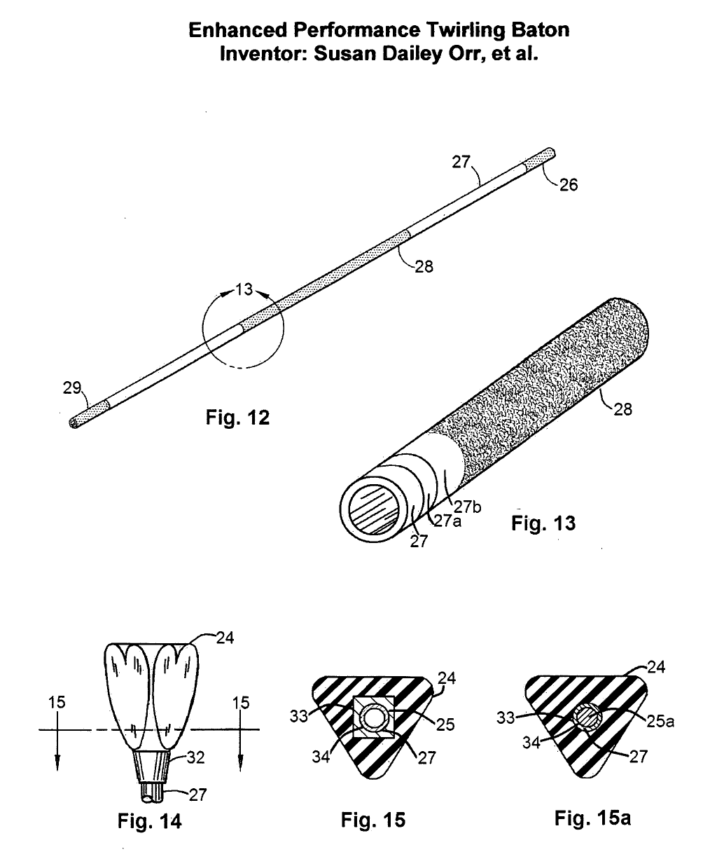

FIG. 12 is a perspective view of the baton shaft showing the non-slip center section of the baton shaft as well as the tip ends of the shaft that have been conditioned to provide a solid bond between the shaft and the rubber ends. These ends are described as detail numbers 29 and 26. They are conditioned by grit blasting the baton shaft and are identical except the tip end is shorter than the ball end due to the fact that the ball end has more rubber surface to bond to the steel shaft. This view also shows where FIG. 13 was taken to provide a better view of the non-slip surface, detail number 28, of the baton shaft.

FIG. 13 is an enlarged view of detail 13. The shaft starts out as 4150 steel and is then heat treated and tempered to a hardness of RC50. It is then polished, cleaned and copper plated. Next it is then nickel plated and finally chrome plated. In order to obtain our non-slip surface which is claim number 8, the chrome plated shaft is grit blasted with a sized and graded media that partially removes the outer chrome layer and leaves the surface abrasive with microscopic cavities and ridges. This surface as shown in FIG. 13 is not rough enough to rip the skin from a twirlers fingers but will cause water to be squeezed out and allow the skin to come in contact with the metal surface. The non-slip surface is expected to last though the period that a twirler uses the baton. For those who expect to experience extreme wear, the non-slip surface can be coated with a superficial hard material such as Titanium Nitrite or other physical vapor deposition materials. For those twirlers that want the center section to be dark or black, a coating of black oxide can also be applied to this section of the baton.

This figure supports claim number 8.

FIG. 14 show where sectional view 15 was taken through the ball end of the baton.

FIG. 15 shows a sectional view of the ball end, counter balance weight and the baton shaft. In this drawing, the rubber end, detail number 24 has a square counter balance weight around the shaft. The bond between the counter balance weight, rubber end and the shaft is accomplished by conditioning the steel components by grit blasting them and running a coarse grit sandpaper sleeve in the rubber caste cavity of the ball end. This roughs up the surface of all components so that epoxy glue can be applied and will permanently bond the components. During bonding, the rubber ball and tip have to be positioned on a flat surface and held in that position until the epoxy has cured thus creating ends of the baton that are timed and securely bonded.

This figure supports claim numbers 2, 3, 4, 5, 6 and 7.

FIG. 15a shows the same sectional view as FIG. 15 except that an alternative balance weight, detail number 24a, has been used. This alternative counter balance weight is conditioned and treated the same way as detail 24. The only reason it has been substituted is for economical production process reasons and does not distract from the functions of the baton.

This figure supports and illustrates claim numbers 2, 3, 4, 5 and 6.

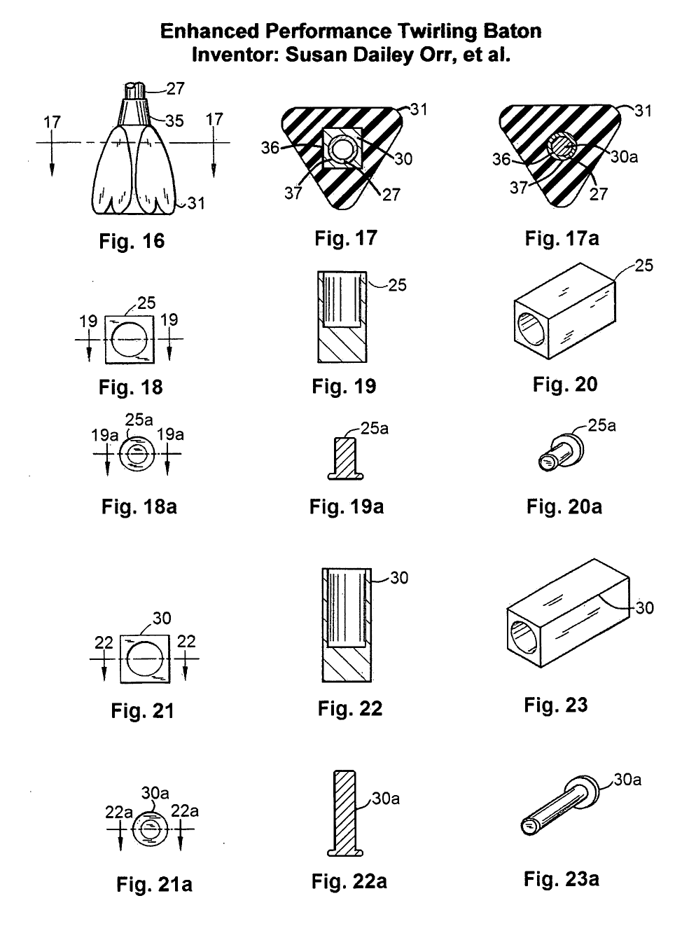

FIG. 16 shows where sectional view 17 was taken through the tip end of the baton.

FIG. 17 shows a sectional view of the tip end, which is detail number 31, counter balance weight, which is detail number 30, and the baton shaft, which is detail number 27. In this drawing, the rubber end, detail number 31, has a square counter balance weight around the shaft. The bond between the counter balance weight, rubber end and the shaft is accomplished by conditioning the steel components by grit blasting them and running a coarse grit sandpaper sleeve in the rubber caste cavity of the of the tip end. This roughs up the surface of all components so that epoxy glue can be applied and will permanently bond the components. During bonding, the rubber ball and tip have to be positioned on a flat surface and held in that position until the epoxy has cured thus creating ends of the baton that are timed and securely bonded.

This figure supports claim numbers 2, 3, 4, 5, 6 and 7.

FIG. 17a shows the same sectional view as FIG. 17 except that an alternative balance weight, detail number 30a, has been used. This alternative counter balance weight is conditioned and treated the same way as detail 30. The only reason it has been substituted is for economical production process reasons and does not distract from the functions of the baton.

This figure supports claim numbers 2, 3, 4, 5 and 6.

FIG. 18 shows where sectional view number 19 was taken through the ball end counter balance weight, detail number 25.

FIG. 18a shows where sectional view number 19a was taken through alternatively designed ball end counter balance weight, detail number 25a.

FIG. 19 is a sectional view of the ball end counter balance weight, detail number 25. This counter balance weight is designed in a square shape, which adds more surface area to be bonded to the rubber ball. Being square, it also reduces the tendency for the rubber ball tip to rotate about the axis of the shaft, which is detail number 27. This square design for the baton counter balance weight is also grit blasted in order to provide a surface that is conditioned for proper bonding to the rubber tip. Epoxy is added both to the inside and outside of the counter balance weight to assure bonding on all sides of the counter balance weight. In FIG. 15, this epoxy is shown as detail numbers 33 and 34. It cannot be seen on an ordinary scale drawing since it is only several thousandths of an inch in thickness.

This drawing illustrates and supports claim numbers 3, 4, 6 and 7.

FIG. 19a is a section view of an alternatively designed counter balance weight that has been designed purely for economical purposes to support cost reduction for the consumer. While not considered quite as strong as the square design, it has been tested and performs sufficiently to provide a solid bond and counter balance effect for keeping the baton balanced about its geometric center.

This drawing supports and illustrates claim number 3, 4 and 6.

FIG. 20 is a perspective view of the ball end counter balance weight, detail number 25.

This drawing is shown as additional support to understand claim number 7.

FIG. 20a is a perspective view of an alternate design of the tip end counter balance weight, detail number 30a.

FIG. 21 shows where sectional view number 22 was taken through the tip end counter balance weight, detail number 30.

FIG. 21a shows where sectional view number 22a was taken through alternatively designed tip end counter balance weight, detail number 30a.

FIG. 22 is a sectional view of the tip end counter balance weight, detail number 30. This counter balance weight is designed in a square shape, which adds more surface area to be bonded to the rubber ball. Being square, it also reduces the tendency for the rubber ball tip to rotate about the axis of the shaft, which is detail number 27. This square design for the baton counter balance weight is also grit blasted in order to provide a surface that is conditioned for proper bonding to the rubber tip. Epoxy is added both to the inside and outside of the counter balance weight to assure bonding on all sides of the counter balance weight. In FIG. 17, this epoxy is shown as detail numbers 36 and 37. It cannot be seen on an ordinary scale drawing since it is only several thousandths of and inch in thickness.

This drawing illustrates and supports claim numbers 3, 4, 6 and 7.

FIG. 22a is a sectional of an alternatively designed counter balance weight that has been designed purely for economical purposes to support cost reduction for the consumer. While not considered quite as strong as the square design, it has been tested and performs sufficiently to provide a solid bond and counter balance effect for keeping the baton balanced about its geometric center.

This drawing supports and illustrates claim number 3, 4, and 6.

FIG. 23 is a perspective view of the tip end counter balance weight, detail number 30.

This drawing is shown as additional support to understand claim number 7.

FIG. 23a is a perspective view of an alternate design of the tip end counter balance weight, detail number 30a.

Process of Manufacturing

The enhanced performance twirling baton is produced by cutting 4150 shaft material into lengths that can be polished, cleaned and plated with nickel and chrome. Next, the shaft material is cut to various baton lengths utilizing a cut off wheel. The ends are next blasted with grit that roughs up the surface so that rubber ends can be securely attached. Next, the center of the baton shaft is blasted to create a non-slip surface. Utilizing a specified and sized blast medium, controlled air pressure and blasting from specified distance from the shaft so that a required micro-finish can be maintained closely controls the non-slip surface. The rubber ends are produced from an injection molding process utilizing a poly isobutylene rubber material. The material is heated prior to injection and is baked for a specified time to cure the synthetic rubber material. Molding flash is removed and the internal section of the baton ends (the ball and tip) are sanded with a coarse sanding sleeve which prepares that surface to be bonded to the steel baton shaft. Counter balance weights are manufactured from bar stock by turning the bar stock down to fit the internal diameter of the baton shaft and they are pressed into the baton shaft. The counter balance weighs are next blasted to prepare the surface to bond to the shaft by utilizing and epoxy adhesive. Epoxy is applied to the shaft and the internal portion of the rubber ends and they are held in position while the epoxy cures leaving the rubber ends properly timed with each other to prevent the baton from rolling. Finally, the completed baton is tested for bond adherence and balance, cleaned and is then packaged into a plastic sleeve for shipping. Labels are placed on the baton that denotes the baton shaft diameter size and length. Batons are produced in two standard sizes. One is ⅜ inch shaft material and the other is 7116 inch shaft material.

Process of Using and Distinguishing Factors

Baton twirlers all over the world use batons. They are an instrument that creates a flashy routine typically performed in front of a marching band either in parades or during halftime shows. The twirler usually starts at an early age, many as young as four years old. The typical successful baton twirler is not self-taught but grows up under the tutelage of a professional baton teacher. By the time the champion baton twirler reached peak performance, they will have experience hundreds of baton contests and public performances. This baton will be utilized exactly the way all other batons are used. The distinguishing features are the shape of the ends, the non-slip finish of the center and the rubber material utilized to reduce the bounce effect when dropped. While it is not our claim to improve the twirler's skills, it is our claim the some of the reasons for poor performance can be reduced by the utilization of this invention. When, for whatever reason, a baton is dropped, it will roll depending on how much energy it has in it when dropped. Because the ends are typically round the baton rolls quickly away from the twirler causing a delay in the performance in order to retrieve the baton. This newly invented baton will not roll as far away, thus allowing the performance to proceed at a smoother and more graceful pace. Many of the drops are a result of sweaty hands or rainy weather. The non-slip surface of our invention will again improve performance by allowing the baton twirler to keep better control and a good grip on the baton. This product has been successfully tested in rainy conditions and with wet hands and has demonstrated that it does in fact distinguish itself from other baton designs. When dropped the baton also has a tendency to bounce away from the twirler. This invention utilized a synthetic rubber that has a reduced bounce affect when compared to other typically produced batons. The polymer used in this baton has a high loss factor or high internal dampening characteristic of which the net result is reduced bounce or better performance for the baton twirler.

What we claim in this invention is listed below:

1. A twirling baton with synthetic rubber-like ends of the baton (ball & tip) are designed in a triangular shape with three flat sides when looking down the axis of the shaft of the baton to prevent excessive rolling when the baton is dropped or thrown to the surface and are bonded and timed or specifically orientated to a steel baton shaft that has counter balance weights to balance the baton and that has a non-slip surface in the center of said shaft.

2. The rubber-like ends referenced in claim 1 are timed and locked so that the flats of the triangular sides are in the same angular orientation to each other about the centerline of the shaft.

3. The rubber-like ends of the baton as referenced in claim 1 are permanently bonded into position to maintain proper orientation about the shaft of the baton.

4. The ends of the baton shaft referenced in claim 1 are conditioned to provide a surface that will allow for a permanent bond between the baton shaft, rubber-like ball and tip and the counter balance weights.

5. The rubber-like material of the ball and tip of the baton referenced in claim 1 is conditioned to create a surface on the rubber-like material that will allow epoxy glue to permanently create a bond between the rubber-like material and the metal surface of the counter balance weights and the baton shaft.

6. The counter balance weights referenced in claim 1 are conditioned to allow permanent adhesion between the metal and the rubber-like material of the baton ends.

7. The counter balance weights referenced in claim 1 are square in design and not only act to balance the baton about its geometric center, but also are timing and locking devices between the shaft and the rubber-like ball and tip to hold triangular shape of the baton ends in the same angular position with respect to each other.

8. The non-slip center section of the baton shaft as set forth in claim 1 is conditioned to create a surface of such consistency and finish that significantly reduce slippage or loss of control by the twirler due to water or moisture but will not harm the fingers of the baton twirler during use.

9. The non slip center section of the baton as set forth in claim 1 is coated by a physical vapor deposition (PVD) process using such materials as titanium nitrite, aluminum nitrite or a ceramic like coating to reduce wear but not take away from the non-slip features of the baton shaft.

10. The center section of the baton as set forth in claim 1 is coated with black oxide or black chrome to change the color to black or dark gray.

11. The non-slip center section of the baton as set forth in claim 1 is created by grit blasting the chrome and nickel plated high carbon steel shaft to a point that a mildly abrasive surface results that suitable for baton twirling but not so abrasive that it harms the baton twirler's fingers.

13. The rubber-like ends of the twirling baton are produced from synthetic rubber polymer that exhibits high loss factors or high internal damping, which is necessary for the reduced bounce characteristics of the enhanced performance twirling baton.

14. The rubber-like material as set forth in claim 13 is poly isobutylene.

15. The rubber-like material as set forth in claim 13 is poly norbornene.

16. The rubber-like material as set forth in claim 13 is poly epichlorohydrin.
